(19) United States
(12) Patent Application Publication
(10) Pub. No.: US 2019/0054922 A1
(43) Pub. Date: Feb. 21, 2019

(54) SYSTEMS AND METHODS FOR AUTOMATICALLY PASSING VEHICLES

(71) Applicant: Faraday&Future Inc., Gardena, CA (US)

(72) Inventors: Veera Ganesh Yalla, Sunnyvale, CA (US); Carlos John Rosario, San Jose, CA (US)

(21) Appl. No.: 15/717,851

(22) Filed: Sep. 27, 2017

Related U.S. Application Data
(60) Provisional application No. 62/401,110, filed on Sep. 28, 2016.

(51) Int. Cl. B60W 30/18; G05D 1/00

(52) U.S. Cl. CPC B60W 30/18163; G05D 1/0088; B60W 2550/22; G05D 2201/0213; B60W 2520/10; B60W 2550/408; B60W 2550/14

(57) ABSTRACT

A system that performs a method is disclosed. The system determines one or more characteristics about an area surrounding a vehicle via one or more sensors (e.g., one or more characteristics about a road on which the vehicle is traveling and/or one or more characteristics about one or more other vehicles on the road) and that one or more vehicle passing criteria are satisfied. The system also determines whether passing is allowed on the road at a current location of the vehicle. In response to the determination of whether passing is allowed: in accordance with a determination that passing is allowed, the system performs an automated pass operation to pass one or more other vehicles. In accordance with a determination that passing is not allowed, the system forgoes performing the automated pass operation to pass the one or more other vehicles.

### CROSS-REFERENCE TO RELATED APPLICATIONS

This application claims the benefit of U.S. Provisional Application No. 62/401,110, filed Sep. 28, 2016, the entirety of which is hereby incorporated by reference.

### FIELD OF THE DISCLOSURE

The various embodiments of the present invention relate generally to automatically passing vehicles on roads.

### BACKGROUND OF THE DISCLOSURE

Vehicles traveling on a one-lane road or highway often find themselves behind slow-driving vehicles such as big rigs, buses, minivans, etc. Drivers can attempt to pass these vehicles (e.g., go around them on the adjacent lane), but such driving maneuvers can be dangerous because of poor road visibility around the slow-driving vehicles and/or blind spots (e.g., inability to see other vehicles and/or objects in the adjacent lane). Therefore, a simple solution to perform automated pass operations can be desirable.

### SUMMARY OF THE DISCLOSURE

Examples of the disclosure are directed to automatically passing vehicles on roads such as one-lane highways. A vehicle in accordance with an embodiment of the present invention can perform automated pass operations as a function of the recognized characteristics of the vehicle's surroundings and in accordance with different vehicle-passing aggression levels.

### BRIEF DESCRIPTION OF THE DRAWINGS

FIG. 1 illustrates an exemplary system block diagram of a vehicle control system according to examples of the disclosure.

FIG. 2 illustrates an exemplary vehicle automatically passing another vehicle according to examples of the disclosure.

FIG. 3 illustrates an exemplary vehicle aggressively passing another vehicle according to examples of the disclosure.

FIG. 4 illustrates an exemplary vehicle automatically passing multiple vehicles according to examples of the disclosure.

FIG. 5 illustrates an exemplary process for determining whether to perform an automated passing maneuver according to examples of the disclosure.

FIG. 6 illustrates an exemplary process for automatically passing vehicles on a road according to examples of the disclosure.

FIG. 7 illustrates an exemplary process for performing a coordinated pass operation according to examples of the disclosure.

FIG. 8 illustrates an exemplary process for performing a safe pass operation according to examples of the disclosure.

FIG. 9 illustrates an exemplary process for automatically detecting and allowing other vehicles to pass according to examples of the disclosure.

### DETAILED DESCRIPTION

In the following description of examples, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to autonomous driving, partially autonomous driving, and/or driver assistance systems.

Some vehicles, such as automobiles, can include various sensors for detecting and gathering information about the vehicles' surroundings, such as information about other vehicles and/or the road. Examples of the disclosure are directed to using this information to perform automated pass operations. The vehicle can also use different vehicle passing aggression levels to perform automated passing maneuvers. It is understood that while the examples of the disclosure describe automatically passing vehicles on one-lane roads, the teachings of the disclosure analogously extend to automatically passing vehicles on multi-lane roads.

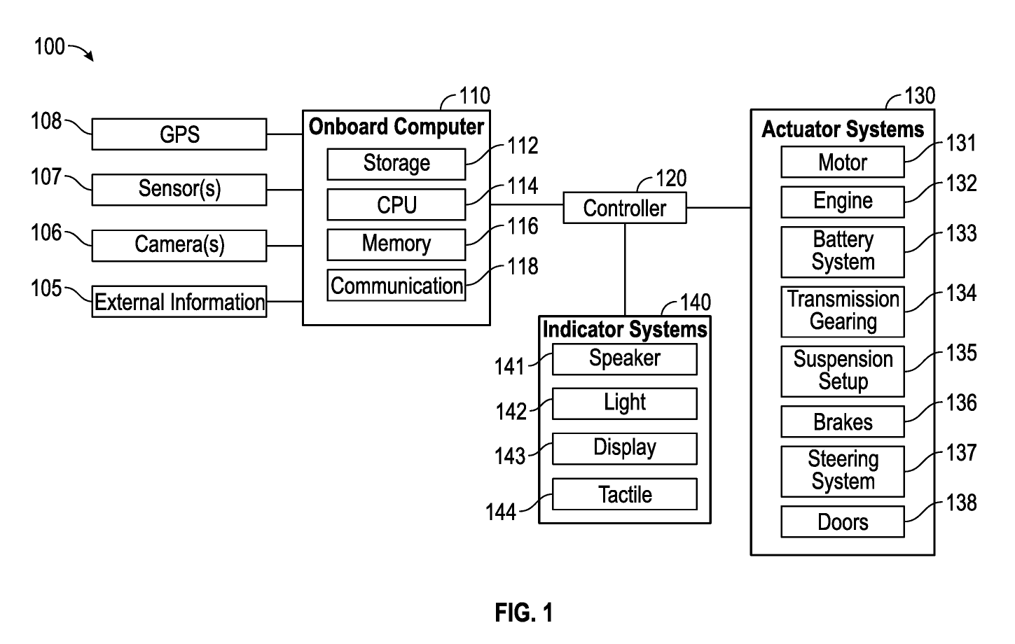

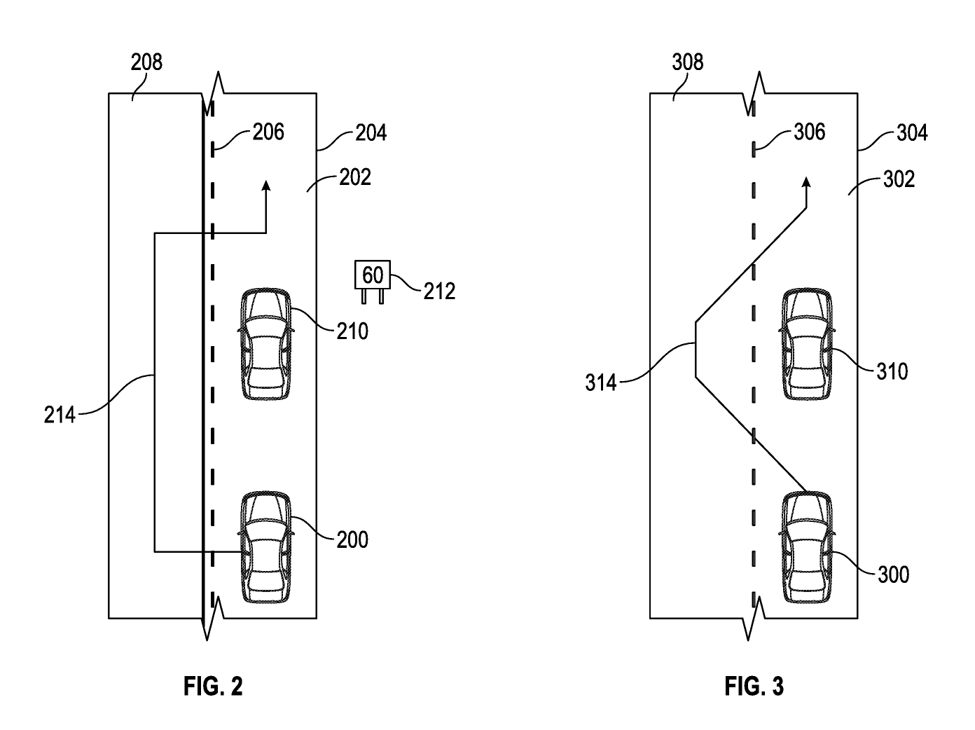

FIG. 1 illustrates an exemplary system block diagram of vehicle control system 100 according to examples of the disclosure. Vehicle control system 100 can perform any of the methods described with reference to FIGS. 2-9. System 100 can be incorporated into a vehicle, such as a consumer automobile. Other example vehicles that may incorporate the system 100 include, without limitation, airplanes, boats, or industrial automobiles. Vehicle control system 100 can include one or more cameras 106 capable of capturing image data (e.g., video data) for determining various characteristics of other vehicles and/or the road, as described below with reference to FIGS. 2-9. Vehicle control system 100 can also include one or more other sensors 107 (e.g., radar, ultrasonic, LIDAR, etc.) capable of detecting various characteristics of other vehicles and a Global Positioning System (GPS) receiver 108 capable of determining the location and/or speed of the vehicle. In some examples, sensor data can be fused together. This fusion can occur at one or more electronic control units (ECUs) (not shown). The particular ECU(s) that are chosen to perform data fusion can be based on an amount of resources (e.g., processing power and/or memory) available to the one or more ECUs, and can be dynamically shifted between ECUs and/or components within an ECU (since an ECU can contain more than one processor) to optimize performance. Vehicle control system 100 can also receive (e.g., via an internet connection) additional external information about other vehicles, the road, weather conditions, map information, route information via an external information interface 305 (e.g., a cellular internet interface, a Wi-Fi internet interface, vehicle-to-vehicle interface, radio interface, or any other wireless communication interface).

Vehicle control system 100 can include an on-board computer 110 that is coupled to the cameras 106, sensors 107, GPS receiver 108, and external information interface 105, and that is capable of receiving the image data from the cameras 106 and/or outputs from the sensors 107, the GPS receiver 108, and external information interface 107. The on-board computer 110 can be capable of performing automated passing operations, as described in this disclosure. On-board computer 110 can include storage 112, memory 116, communications circuitry 118, and processor 114. Processor 114 can perform any of the methods described with reference to FIGS. 2-9. Additionally, communications 118 can perform any of the communication actions described with reference to FIGS. 2-9. For example, communications interface 118 can send and/or receive vehicle and/or road data to the user, other vehicles, or any third party. Moreover, storage 112 and/or memory 116 can store data (such as map and/or route information) and instructions (such as vehicle passing aggression level settings) for performing any of the methods described with reference to FIGS. 2-9. Storage 112 and/or memory 116 can be any non-transitory computer-readable storage medium, such as a solid-state drive or a hard disk drive, among other possibilities. The vehicle control system 100 can also include a controller 120 capable of controlling one or more aspects of vehicle operation, such as performing automated passing operations by the on-board computer 110.

In some examples, the vehicle control system 100 can be connected to (e.g., via controller 120) one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. The vehicle control system 100 can control, via controller 120, one or more of these actuator systems 130 during vehicle operation; for example, to control the vehicle during autonomous driving operations, such as automated passing operations, using the motor 131 or engine 132, battery system 133, transmission gearing 134, suspension setup 135, brakes 136, and/or steering system 137, etc. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control, entertainment, heads up display system(s) in the vehicle), and one or more tactile actuators 144 in the vehicle (e.g., as part of a steering wheel or seat in the vehicle). The vehicle control system 100 can control, via controller 120, one or more of these indicator systems 140 to provide visual and/or audio indications to a user. In some examples, on-board computer 110 can store in its memory 116 different vehicle passing aggression levels which includes particular settings of how the controller 120 controls the motor 131, battery system 133, transmission gearing 134, suspension 135, brakes 136, steering system 137, etc., when the vehicle is at a particular vehicle aggression level. Similarly, on-board computer 110 can also include in its memory 116 program logic that determines when and where to merge back into the driving lane (whether to complete or abort the automated passing operation) using inputs from one or more of the cameras 106, sensors 106, GPS receiver 108, and/or external information 105. When certain conditions are met, as described in this disclosure, on-board computer 110 can instruct the controller 120 to set the actuator systems 130 into a setting corresponding to a new vehicle passing aggression level.

FIG. 2 illustrates an exemplary vehicle 200 driving on driving lane 202 of road 204 according to examples of the disclosure. Vehicle 200 can include various sensors for determining one or more characteristics about the vehicle's surroundings (e.g., as described above with reference to FIG. 1). These sensors can include cameras, radar sensors, ultrasonic sensors, laser sensors, LIDAR sensors, or any other sensors that can be used to detect one or more characteristics about the vehicle's surroundings. These sensors can be configured on vehicle 200 to provide it with 360 degree (or other) coverage of the area surrounding the vehicle. Vehicle 200 can process data from one or more of these sensors to determine one or more characteristics about road 204 and/or one or more characteristics about one or more other vehicles on the road. For example, vehicle 200 can process data from one or more of the sensors to recognize lane markings 206, objects on road 204, and/or the curvature, incline, decline, traffic signs, traffic lights, merging lanes, highway entrances, highway exits, cross streets, surface material of the road (e.g., pavement, dirt, asphalt, or gravel), the conditions of the surface material (e.g., wet, icy, or containing potholes), construction sites, road blocks, or any other characteristics or conditions of the road. In another example, vehicle 200 can process data from one or more of the sensors to monitor the location, heading, speed (including acceleration and/or deceleration), lights, or any other characteristics of other vehicles on road 204. For example, vehicle 200 can process from one or more of the sensors to monitor one or more other vehicles driving on driving lane 202, adjacent lane 208, and/or merging into or out of driving lane 202 and/or adjacent lane 208. For example, vehicle 200 can detect vehicle 210 driving along driving lane 202 at 50 miles per hour by processing data from its cameras, radar sensors, ultrasonic sensors, laser sensors, and/or LIDAR sensors. Vehicle 200 can also determine that the speed limit of road 204 is 60 miles per hour by processing data from its cameras to recognize and/or analyze sign 212 (e.g., using known pattern-recognition techniques). Vehicle 200 can also process data from its sensors to determine that passing is allowed in the current stretch of road 204 by recognizing and/or analyzing road markings 206 (e.g., using known pattern-recognition techniques). For example, vehicle 200 can maintain in memory (locally or remotely) a collection of road marking patterns that allow passing (e.g., a single dotted line, or a solid line and a dotted line adjacent to the vehicle) and/or road markings that do not allow passing (e.g., two or more solid yellow lines, or a dotted line and a solid line adjacent to the vehicle) and compare and/or match those patterns to the road markings 206 captured by the vehicle's cameras. Using this information, vehicle 200 can automatically pass vehicle 210 from adjacent lane 208 along path 214 (e.g., as described in further detail below). Notably, vehicle 200 can monitor one or more characteristics about its surroundings via its sensors while driving along path 214 to avoid a collision with vehicle 210, another vehicle, or any other object (e.g., to abort the automated pass operation).

In some examples, vehicle 200 can be operating in an automated driving mode (e.g., driving autonomously without user input), in an assisted driving mode (e.g., allowing automated driving operations such as automatically changing lanes, slowing down, pulling over, or any other automated driving operation), or in a manual driving mode (e.g., a driver controlling all driving operations) when it performs automated passing procedures. In some examples, vehicle 200 can notify a user that the vehicle will be or is performing an automated vehicle passing operation while the vehicle is operating in the automated driving mode. In some examples, the notification can be a visual, haptic, and/or audio alert to the user. In some examples, the notification can be on any of the vehicle's display system(s) (e.g., the control, entertainment, infotainment, and/or heads up display system(s)), a smartphone, or any other electronic device with a display. In some examples, the vehicle can provide an audible notification through the vehicle's speaker(s) or any other sound source in the vehicle. In some examples, the notification can be a phone call, text message, email, or any form of electronic or audible/visual communication to an electronic device. In some examples, the user can abort the automated passing operations through a control system such as a button, a touch screen, a voice command, a computer, a smartphone, or any device or system that allows user input to be entered. In some examples, the vehicle can prompt the user to input whether to pass one or more other vehicles while the vehicle is operating in the assisted driving mode or the manual driving mode. Similar to the notification in the automated driving mode, a prompt can be visual and/or audible, and the user can accept or reject the automated passing operation through a control system such as a button, a touch screen, a voice command, a computer, a smartphone, or any device or system that allows user input to be entered. In some examples, the driver, a user, a passenger, or a designated third party can manually invoke passing operations under any driving mode through a control system such as a button, a touch screen, a voice command, a computer, a smartphone, or any device or system that allows user input to be entered.

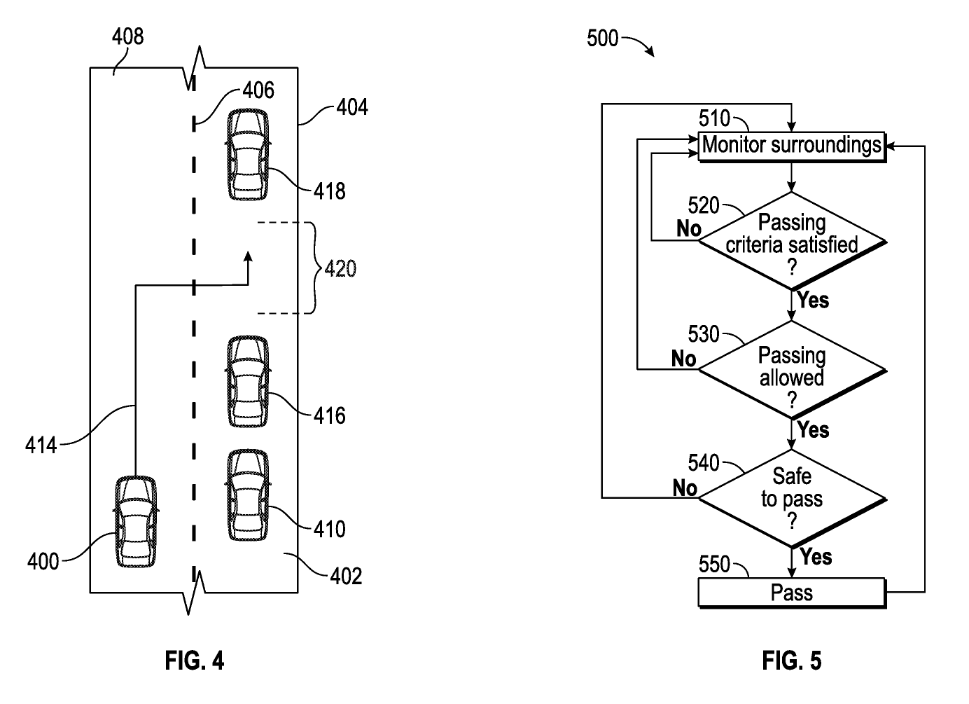

FIG. 3 illustrates an exemplary vehicle aggressively passing another vehicle according to examples of the disclosure. Vehicle 300 can be configured to have multiple vehicle passing aggression levels (e.g., low, moderate, and/or high). For example, in a low vehicle passing aggression level, the vehicle can be configured to only pass stopped vehicles (e.g., broken down vehicles or vehicles involved in a collision) or a vehicle driving below a speed threshold (e.g., 20 miles per hour below the posted speed limit). In some examples, the low vehicle passing aggression level can be configured to perform only coordinated pass operations with other autonomous vehicles as described in further detail below. In some examples, the low vehicle aggression level can be configured to automatically pass only one other vehicle at a time. In a moderate vehicle passing aggression level, the vehicle can be configured to automatically pass any vehicle traveling below the posted speed limit (e.g., as described above with reference to FIG. 2). In some examples, the moderate vehicle passing aggression level can be configured to automatically pass multiple vehicles at a time (e.g., as described below with reference to FIG. 4). In a high vehicle passing aggression level, the vehicle can be configured to perform aggressive driving maneuvers to pass one or more other vehicles. For example, vehicle 300 can be operating under the high vehicle passing aggression level when it detects that vehicle 310 is driving 5 miles per hour below the posted speed limit and that lane markings 306 allow passing. Vehicle 300 can automatically accelerate and/or take an aggressive passing path 314 to pass vehicle 310. Such aggressive acceleration and/or passing path can allow vehicle 300 to quickly pass vehicle 310 while minimizing the time spent driving in lane 308. Notably, vehicle 300 can be configured to include any combination of the low, moderate, or high vehicle passing aggression levels. In some examples, the configuration of the aggression levels can be done and updated by the manufacturer, the owner, or any third party.

In some examples, a user, a passenger, or any third party can transition between vehicle passing aggression levels manually (e.g., through a control system such as a button, a touch screen, a voice command, a computer, a smartphone, or any device or system that allows user input to be entered). For example, the vehicle can be operating in an automated driving mode with the vehicle passing aggression level set to low. The driver can then push a button on the control system to set the vehicle passing aggression level to high. In other examples, the owner or any designated third party can set restrictions on available vehicle passing aggression levels (e.g., set parental controls). For example, a vehicle owner may restrict the vehicle passing aggression level of the vehicle to low whenever it is being operated by an inexperienced driver. These restrictions/configurations can be entered through a control system such as a button, a touch screen, a voice command, a computer, a smartphone, or any device or system that allows user input to be entered. In some examples, these restrictions/configurations can be tied to a key (e.g., the vehicle can have specialized vehicle aggression levels that depend on the key being used). As another example, these restrictions/configurations can be associated with a user profile (e.g., a vehicle may pass a second vehicle in the manner illustrated in FIG. 2 if a first user is operating and/or riding in the vehicle, while a vehicle may pass another vehicle in the manner illustrated in FIG. 3 if a second, different user is operating and/or riding in the vehicle).

In some examples, the transitions between vehicle aggression levels can be automatic. For example, the vehicle can be operating in an automated driving mode with the vehicle passing aggression level set to high when the vehicle's power falls below a threshold (e.g., below 50% of its capacity). The vehicle can then automatically lower the aggression level to moderate or low. In some examples, the vehicle can automatically prompt the user to select a lower vehicle passing aggression level (or allow the user to abort the transition altogether). In some examples, the vehicle can automatically set the vehicle passing aggression level to high (or any other elevated vehicle passing aggression level) once the vehicle is charged above a threshold (e.g., above 70% of its capacity). In some examples, the user can manually set the threshold limits for when the vehicle automatically transitions between vehicle passing aggression levels.

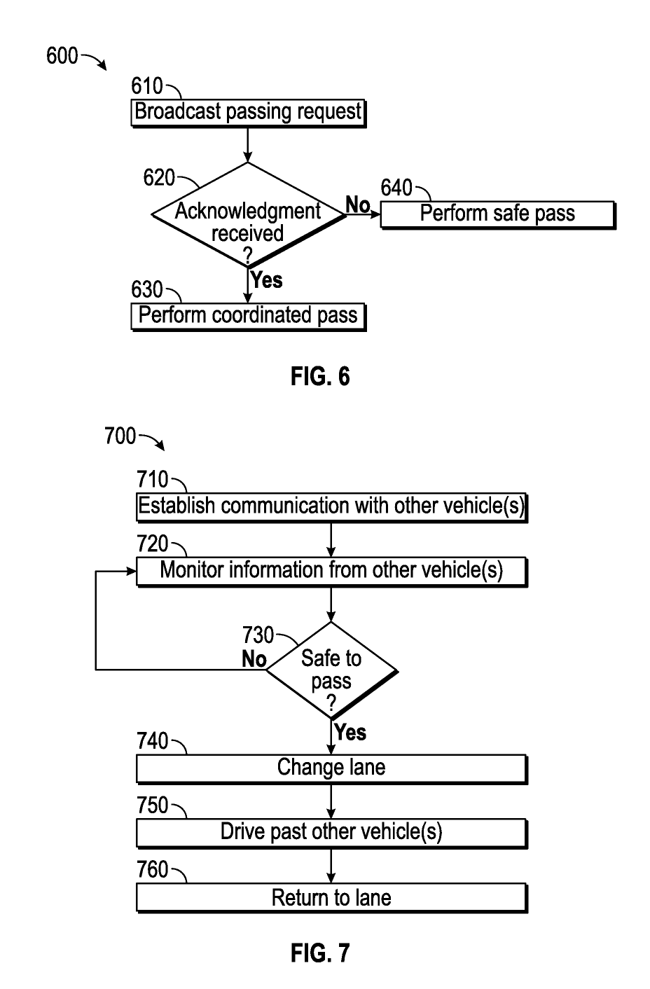

FIG. 4 illustrates an exemplary vehicle automatically passing multiple vehicles according to examples of the disclosure. Vehicle 400 can be performing a coordinated pass or a safe pass operation (e.g., as described below with reference to FIGS. 6-9). For example, in a coordinated pass operation, vehicle 400 can communicate with vehicle 416 and/or vehicle 418 to create and/or maintain lane entry point 420 (a gap between two vehicles in the same lane that is big enough for vehicle 400 to safely merge into) (e.g., as described below with reference to FIGS. 6-7). In some examples, vehicle 400 can also communicate with vehicle 410 or any other vehicle (including any vehicles in adjacent lane 408). In another example, vehicle 400 can be performing a safe pass operation where it does not have an open line of communication with vehicle 416 or any other vehicle (e.g., as described below with reference to FIGS. 6 and 8-9). In that instance, vehicle 400 can process data from one or more of its sensors to identify lane entry point 420 (e.g., as described below with reference to FIGS. 7-9). In some examples, vehicle 400 can process data from one or more of its sensors to monitor the size of lane entry point 420 (e.g., the distance between vehicle 416 and vehicle 418) until it successfully merges back into driving lane 402 (e.g., completes the automated pass operation). In this way, vehicle 400 can identify a different lane entry point if vehicle 416 were to speed up closer to vehicle 418 or if vehicle 418 were to slow down closer to vehicle 416 (e.g., if lane entry point 420 were too narrow or close making it unsafe for vehicle 400 to merge into driving lane 402 at that entry point). In some examples, vehicle 400 can process data from one or more of its sensors to monitor oncoming vehicles or objects in adjacent lane 408 (e.g., as described below with reference to FIGS. 5 and 7-8). In this way, vehicle 400 can abort the passing operation (e.g., slow down and return to driving lane 402 or pull over to the shoulder) if necessary to avoid a collision. In some examples, vehicle 400 can receive data from one or more of vehicles 410, 416, and/or 418 (e.g., in addition to data received from sensors included in vehicle 410). For example, vehicle 400 can receive data from the sensors of one or more of vehicles 410, 416, and/or 418 and process that data (in combination or instead of data from its own sensors) to determine one or more characteristics about road 404 and/or one or more characteristics about one or more other vehicles. For example, vehicle 400 can receive and process data from the cameras on vehicle 418 during automated pass operations (e.g., from prior to entering adjacent lane 408 to merging back into driving lane 402). In this way, vehicle 400 can have access to additional data to help avoid accidents during automated passing operations. In some examples, vehicle 400 can also receive data from vehicles in adjacent lane 408. Information associated with vehicles or objects in adjacent lane 408 may include an oncoming vehicle's speed, the size of an object in adjacent lane 408, and information associated with a determination that vehicle 400 can drive through an object (e.g., a plastic bag) located in adjacent lane 408 without aborting a passing operation.

FIG. 5 illustrates an exemplary process for determining whether to perform an automated passing maneuver according to examples of the disclosure. Process 500 can be performed continuously or repeatedly by the vehicle during driving operations in an automated driving mode or an assisted driving mode. Process 500 can also be invoked by the user at any time during driving operations in any driving mode (e.g., as described above with reference to FIGS. 2-3).

At step 510, process 500 can monitor a vehicle's surroundings by processing data from one or more of the vehicle's sensors to determine one or more characteristics about a road and/or one or more characteristics about one or more other vehicles on the road (e.g., as described above with reference to FIGS. 1-4). For example, process 500 can determine the speed of one or more other vehicles on the same road by processing data from its cameras, radar sensors, ultrasonic sensors, laser sensors, and/or LIDAR sensors at step 510. Process 500 can also determine that the speed limit of the road by processing data from its cameras (e.g., using known pattern-recognition techniques) and/or from information retrieved from a canonical source and/or highly automated driving (HAD/HD) map. In this way, process 500 can determine whether the one or more vehicles are traveling at, below, or above the speed limit of the road. In some examples, process 500 can also compare the speed of the one or more vehicles to the speed of the vehicle to determine whether the one or more vehicles are traveling at a speed slower than the vehicle. In some examples, process 500 can monitor external information such as weather conditions (e.g., whether it is currently or was recently snowing or raining), map information, including information about the surface material of the road (e.g., pavement, dirt, asphalt, or gravel), and/or information from other vehicles, including information about their planned routes, at step 510. In some examples, this external information can be monitored through the vehicle's sensors or can be obtained from an external source (e.g., from another vehicle and/or an internet source) (e.g., as described above with reference to FIGS. 1-4).

At step 520, process 500 can determine whether passing criteria has been satisfied. In some examples, process 500 can determine that the passing criteria are satisfied when there is another one or more vehicles in front of it that are driving below the speed limit. In some examples, process can determine that the passing criteria are not satisfied if the one or more vehicles in front of it are driving at or above the speed limit. In some examples, process 500 can implement the vehicle passing aggression levels at step 520 (e.g., as discussed above with reference to FIG. 3). For example, process 500 can determine that the passing criteria is satisfied at step 520 if the vehicle is operating under the low vehicle passing aggression level and another vehicle in front of it breaks down (e.g., stops and turns on its hazard lights). In another example, process 500 can determine that the passing criteria is satisfied at step 520 if the vehicle is operating under the moderate vehicle passing aggression level and another vehicle in front of it is driving below a threshold speed (e.g., driving 25 miles per hour below the speed limit of the road). In another example, process 500 can determine that the passing criteria is satisfied at step 520 if the vehicle is operating under the high vehicle passing aggression level and a platoon of vehicles (e.g., a group of vehicles autonomously driving in line and/or communicating with other vehicles to conserve resources) in front of it are driving below a threshold speed (e.g., 3 miles per hour under the speed limit). In some examples, process 500 can determine the speed limit by using the vehicle's sensors (e.g., as described above with reference to FIGS. 2-3) or by using map information. In accordance with a determination that passing criteria has been satisfied, process 500 transitions to step 530. In accordance with a determination that passing criteria has not been satisfied, process 500 returns to step 510.

At step 530, process 500 can determine whether passing is allowed at the current stretch of the road where the vehicle is located. For example, process 500 can process data from one or more of the vehicle's sensors to determine if the lane markings and/or posted traffic signs allow passing (e.g., as described above with reference to FIGS. 1-3). In other examples, process 500 can also make this determination by using map information in conjunction with or instead of its sensor data. In accordance with a determination that passing is allowed, process 500 transitions to step 540. In accordance with a determination that passing is not allowed, process 500 returns to step 510. For example, process 500 can look up map information to determine that passing is only allowed for the next 200 feet. While the vehicle's sensor data would indicate that passing is allowed, process 500 would make the determination that passing is not allowed and transition to step 510 because the vehicle would be unable to complete the pass operation within the particular stretch of road that allows passing.

At step 540, process 500 can determine whether it is safe to perform an automated passing maneuver. For example, process 500 can process data from one or more of the vehicle's sensors to determine whether there is oncoming traffic, another passing vehicle, and/or any other object in the adjacent passing lane to determine whether it would be safe to perform an automated passing maneuver. The presence of any such conditions would be indicative to process 500 that it would be unsafe to perform an automated passing maneuver. The absence of any such conditions would be indicative to process 500 that it would be safe to perform a passing maneuver. For example, process 500 can processes data from its cameras, radar sensors, ultrasonic sensors, laser sensors, and/or LIDAR sensors to detect one or more other vehicles or one or more objects in the adjacent lane. Vehicle 200 can also process data from these sensors to determine the speed and/or heading of the one or more vehicles. In this way, process 500 can determine whether the one or more vehicles in the passing lane are traveling toward or away from the vehicle. If the one or more vehicles are traveling toward the vehicle (e.g., oncoming traffic or a passing vehicle coming from behind the vehicle in the passing lane), process 500 can determine that it is not safe to perform the automated passing maneuver at step 540. If the one or more vehicles are traveling away the vehicle, process 500 can determine that it is not safe to perform the automated passing maneuver at step 540. In another example, process 500 can use map information to recognize that the road will curve in the next 100 yards and will create a blind spot for the vehicle's sensors, and determine that it would not be safe to perform an automated passing operation. In another example, process 500 can use route information to recognize that the vehicle will be exiting the highway in 200 feet and determine that it would be unsafe to perform an automated passing maneuver. In another example, process 500 can process data from one or more of the vehicle's sensors and/or use map information to recognize that the vehicle is driving uphill and the vehicle's one or more sensors do not have visibility beyond the horizon and determine that it would be unsafe to perform an automated passing maneuver. For example, process 500 can determine that the vehicle is traveling uphill by monitoring the vehicle's accelerometer and/or gyroscope data. In another example, process 500 can process data from one or more of the vehicle's sensors and/or lookup weather information from an external source (e.g., another vehicle and/or an interne source) to determine that there are poor weather conditions (e.g., rainy, windy, snowy, and/or icy conditions) and determine that it would be unsafe to perform an automated passing operation. In accordance with a determination that it would not be safe to perform an automated passing maneuver, process 500 returns to step 510. In accordance with a determination that it is safe to perform an automated passing operation, process 500 transitions to step 550. At step 550, process 500 can perform an automated passing maneuver (e.g., as described with reference to FIGS. 1-4 and 7-8).

FIG. 6 illustrates an exemplary process for automatically passing vehicles on a road according to examples of the disclosure. In some examples, process 600 can implement step 550 of process 500. In some examples, process 600 can be invoked by a user manually through a control system such as a button, a touch screen, a voice command, a computer, a smartphone, or any device or system that allows user input to be entered.

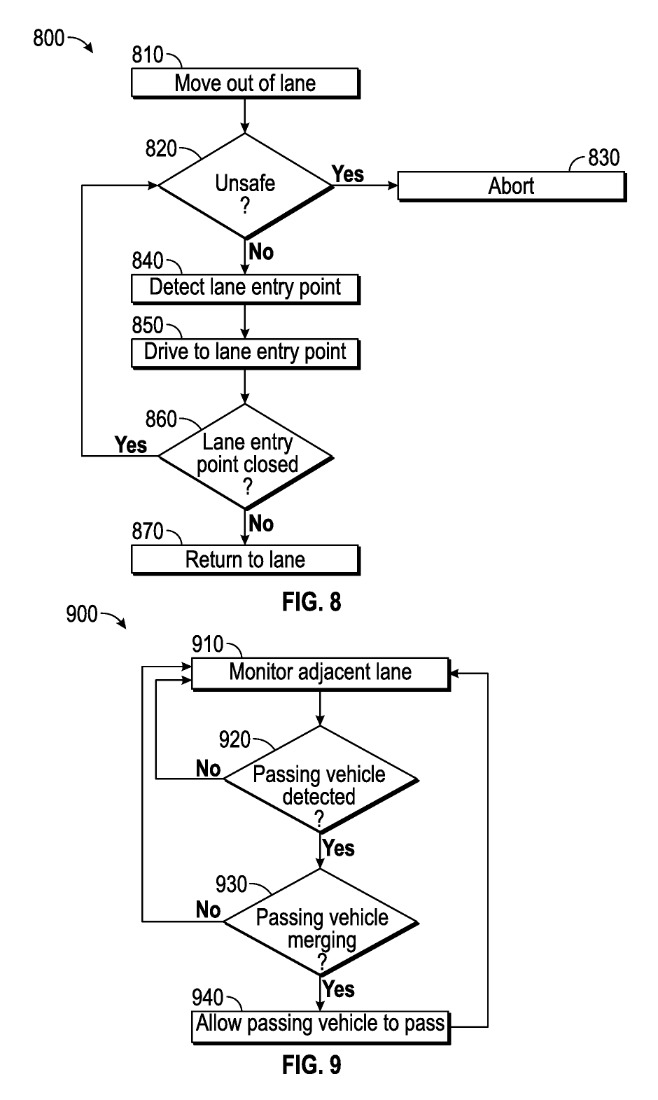

At step 610, process 600 can broadcast a vehicle passing request to one or more other vehicles on a road (e.g., through vehicle-to-vehicle, Internet, cellular, radio, or any other wireless communication channels and/or technologies). At step 620, process 600 determines whether an acknowledgement from one or more of the other vehicles has been received. In some examples, the acknowledgement can include information of whether one or more of the other vehicles are willing or capable of performing a coordinated vehicle passing operation (e.g., as described in detail below with reference to FIG. 7). In accordance with a determination that an acknowledgment has been received, process 600 transitions to step 630 to perform a coordinated pass operation (e.g., as described with reference to FIGS. 3-4 and 7). In accordance with the determination that an acknowledgement from one or more other vehicles has not been received (e.g., the request timed out after a set period of time, such as 5, 10, 15, or any other number of seconds), process 600 transitions to step 640 to perform a safe pass operation (e.g., as described with reference to FIGS. 4 and 8).

FIG. 7 illustrates an exemplary process 700 for performing a coordinated pass operation according to examples of the disclosure. In some examples, process 700 can implement step 630 of process 600. In some examples, process 700 can be performed when a vehicle is platooning (e.g., driving in line and/or communicating with other vehicles to conserve resources). In some examples, process 700 can be manually invoked by a user through a control system such as a button, a touch screen, a voice command, a computer, a smartphone, or any device or system that allows user input to be entered.

At step 710, process 700 can establish a communications link with one or more other vehicles on the same road and/or road infrastructure (e.g., through vehicle-to-everything (V2X), Internet, cellular, radio, or any other wireless communication channels and/or technologies). In some examples, the communications link with the one or more other vehicles can allow the vehicle to receive data from the one or more sensors of the one or more other vehicles (e.g., as described above with reference to FIGS. 1-6). In some examples, this communications link with the one or more other vehicles and/or road infrastructure can include information about one or more characteristics about the road and/or one or more characteristics about the one or more other vehicles. For example, the one or more other vehicles and/or road infrastructure can send information about oncoming traffic (e.g., speed, acceleration, and/or deceleration), information about the one or more other vehicles (e.g., speed, acceleration, deceleration, and/or space between vehicles), information about the other vehicle's planned driving route (e.g., what exit the vehicle plans to take), weather information, road information (including information about the road's condition, markings, posted traffic signs, curvature, incline, decline, or any other information about the road), and/or map information (e.g., as described above with reference to FIGS. 1 and 5). For examples, process 700 can receive raw video data from one or more other vehicles and/or the road infrastructure. In some examples, process 700 can display the communicated information from the one or more other vehicles or the road infrastructure in the vehicle's display system(s) (e.g., the control, entertainment, infotainment, and/or heads up display system(s)), a smartphone, or any other electronic device with a display. For example, process 700 can display a live feed of the camera data received from the one or more vehicles or the road infrastructure in the vehicle's display system. In some examples, the vehicle can be platooning and/or will already have a communications link established with one or more other vehicles in the platoon. In that instance, process 700 can skip step 710 and transition to step 720.

At step 720, process 700 monitors information received from one or more other vehicles, road infrastructure, and/or any other external source (e.g., cloud service or internet source). For example, process 700 can process data received from the one or more other vehicles to determine one or more characteristics about a road and/or one or more characteristics about one or more other vehicles on the road (e.g., as described above with reference to FIGS. 1 and 4). In some examples, process 700 can monitor other information received from the one or more other vehicles and/or road infrastructure such as weather conditions (e.g., whether it is currently or was recently snowing or raining), map information, information about the surface material of the road (e.g., pavement, dirt, asphalt, or gravel), and/or information from other vehicles, including information about their planned routes. In some examples, this external information can be monitored through the one or more other vehicles' sensors (e.g., as described above with reference to FIGS. 1-5) or can be obtained from an external source (e.g., another vehicle and/or an internet source).

At step 730, process 700 can determine whether it is safe to perform an automated passing maneuver. Notably, step 730 can process information in the same manner as step 540 of process 500 but with the benefit of any information received from the one or more other vehicles and/or road infrastructure. For example, process 700 can process data from one or more of the vehicle's sensors and/or data from the one or more other vehicles and/or road infrastructure to determine whether there is oncoming traffic, another passing vehicle, and/or any other object in the adjacent passing lane to determine whether it would be safe to perform an automated passing operation (e.g., as described above with reference to FIG. 5). The presence of any such conditions would be indicative to process 700 that it would be unsafe to perform an automated passing maneuver. For example, process 700 can use information received from the one or more other vehicles (e.g., data from the one or more other vehicles' cameras, radar sensors, ultrasonic sensors, laser sensors, and/or LIDAR sensors) to recognize that another vehicle is fast approaching in the adjacent passing lane and determine that it would not be safe to perform an automated passing maneuver. In another example, process 700 can receive and use route information from the one or more other vehicles and/or road infrastructure to recognize that the one or more other vehicles will be exiting the highway in a quarter mile and determine that it would be unsafe (or unnecessary) to perform an automated passing maneuver. In another example, process 700 can process data from one or more other vehicles (e.g., data from the one or more other vehicles' cameras, accelerometers, gyroscopes, radar sensors, ultrasonic sensors, laser sensors, and/or LIDAR sensors and/or map information) to recognize that the vehicle is driving uphill and that neither the vehicle nor the one or more other vehicles that it is receiving information from have visibility beyond the horizon and determine that it would be unsafe to perform an automated passing maneuver (e.g., as described above with reference to FIG. 5). For example, process 700 can look up map information for the current road and determine that the road is at an incline, and determine that it would be unsafe to perform an automated passing maneuver. In accordance with a determination that it would be safe to perform an automated passing maneuver, process 700 transitions to step 740. In accordance with a determination that it would not be safe to perform an automated passing maneuver, process 700 returns to step 720. In some examples, process 700 can abort the coordinated pass operation in accordance with a determination that it would not be safe to perform an automated passing maneuver.

At step 740, process 700 causes the vehicle to change lanes (e.g., enter the adjacent lane as described with reference to FIGS. 2-4). In some examples, process 700 can cause the vehicle to quickly and/or aggressively change lanes if the vehicle passing aggression level is set to high (e.g., as described above with reference to FIGS. 1, 3, and 5). In some examples, process 700 can cause the vehicle to slowly and/or cautiously change lanes if the vehicle passing aggression level is set to low or moderate (e.g., as described above with reference to FIGS. 1, 3, and 5). In some examples, process 700 continues to monitor information from the one or more other vehicles and from its one or more sensors at step 740. In this way, process 700 can abort the automated lane change operation at any time.

At step 750, process 700 causes the vehicle to speed up past the one or more other vehicles (or a subset thereof) (e.g., as described above with reference to FIGS. 2-4). In some examples, the one or more other vehicles will communicate to the vehicle how many vehicles to drive past (e.g., will communicate the lane entry point as described with reference to FIG. 4). In some examples, process 700 continues to monitor information from the one or more other vehicles, road infrastructure, and/or from its one or more sensors at step 750. In this way, process 700 can abort the automated lane change operation at any time.

At step 760, process 700 causes the vehicle to return to the driving lane at the lane entry point. In some examples, process 700 can cause the vehicle to quickly and/or aggressively merge back into the driving lane if the vehicle passing aggression level is set to high (e.g., as described above with reference to FIGS. 1, 3, and 5). In some examples, process 700 can cause the vehicle to slowly and/or cautiously merge back into the driving lane if the vehicle passing aggression level is set to low or moderate (e.g., as described above with reference to FIGS. 1, 3, and 5). In some examples, process 700 maintains the communications link open with the one or more other vehicles.

It is important to note that the one or more other vehicles can coordinate to maintain and/or create a lane entry point for the vehicle at any step of process 700. For example, the one or more other vehicles can slow down and create the lane entry point by creating a gap between two vehicles big enough for the vehicle to safely merge into. In another example, the one or more other vehicles can measure the distance between each of the one or more other vehicles to recognize a gap between vehicles big enough for the vehicle to merge into. Once the lane entry point is determined, the one or more other vehicles can monitor their speed and the size of the gap so as to maintain the lane entry point. In some examples, the one or more other vehicles can create a different lane entry point in an emergency scenario that causes the vehicle to abort the automated lane passing operation (e.g., to avoid a collision with an oncoming vehicle in the adjacent lane). In this way, the vehicle will have a new lane entry point to immediately return to the driving lane.

FIG. 8 illustrates an exemplary process 800 for performing a safe pass operation according to examples of the disclosure. In some examples, process 800 can implement step 640 of process 600. In some examples, process 800 can be manually invoked by a user through a control system such as a button, a touch screen, a voice command, a computer, a smartphone, or any device or system that allows user input to be entered.

At step 810, process 800 causes the vehicle to move out of the driving lane (e.g., as described with reference to FIGS. 2-3). In some examples, process 800 can cause the vehicle to slightly move out of the driving lane to provide the vehicle's one or more sensors additional visibility of the road (e.g., around the one or more other vehicles it is trying to pass) before completely moving out of the driving lane. In this way, process 800 can abort the automated lane change operation at any time (e.g., safely return to the driving lane) if process 800 detects an oncoming vehicle in the adjacent passing lane (e.g., oncoming traffic or another passing vehicle) or any other object in the adjacent passing lane. In some examples, process 800 can cause the vehicle to quickly and/or aggressively move out of the driving lane (and into the passing lane) if the vehicle passing aggression level is set to high (e.g., as described above with reference to FIGS. 1, 3, and 5). In some examples, process 800 can cause the vehicle to slowly and/or cautiously move out of the driving lane (and into the passing lane) if the vehicle passing aggression level is set to low or moderate (e.g., as described above with reference to FIGS. 1, 3, and 5). Once process 800 causes the vehicle to safely move out of the driving lane and into the adjacent passing lane, process 800 transitions to step 820.

At step 820, process 800 continues to monitor information from its one or more sensors and can determine whether it is safe to perform the automated passing maneuver. For example, process 800 can process data from its one or more sensors to detect that another vehicle is fast approaching in the passing lane and determine that it would not be safe to perform the automated passing maneuver. In another example, process 800 can process data from its one or more sensors to detect that the vehicle is driving uphill and that the vehicle does not have visibility beyond the horizon and determine that it would be unsafe to perform the automated passing maneuver (e.g., as described above with reference to FIGS. 5 and 7). In another example, process 800 can process data from one or more of its sensors to detect that the one or more other vehicle's the vehicle is trying to pass are speeding up (e.g., will likely not allow the vehicle to pass) and determine that it would be unsafe to perform the passing maneuver. In another example, process 800 can process data from its one or more sensors and determine that it would be safe to perform the pass operation because it did not detect any vehicles or objects on the adjacent passing lane. In accordance with a determination that it would be safe to perform an automated passing operation, process 800 transitions to step 840. In accordance with a determination that it would not be safe to perform an automated passing operation, process 800 transitions to step 830.

At step 830, process 800 can safely abort the passing operation (e.g., to avoid a collision). For example, process 800 can cause the vehicle to return to the driving lane. If it is not possible for the vehicle to return to the driving lane from its current position (e.g., because there are one or more vehicles in its way on the driving lane), process 800 can cause the vehicle to slow down (or speed up) and return to the driving lane at another point at step 830. In some examples, process 800 can cause the vehicle to pull over to the shoulder to avoid a collision. In some examples, process 800 can transition to step 830 from any step (e.g., from steps 810, 840, 850, 860, and/or 870) to avoid a collision and/or if manually invoked by the user (e.g., as described above).

At step 840, process 800 can process data from one or more of its sensors to detect a lane entry point (e.g., a gap between two vehicles in the driving lane that is big enough for the vehicle to safely merge into or an area ahead of one or more other vehicles in the driving lane). In some examples, process 800 can transition to step 830 and abort the automated pass operation if a lane entry point is not detected after a threshold time (e.g., 10 seconds, 30 seconds, or 1 minute). In some examples, process 800 will simultaneously speed up (e.g., drive past one or more other vehicle) while attempting to detect a lane entry point). In accordance with detecting a lane entry point, process 800 will transition to step 850.

At step 850, process 800 can cause the vehicle to speed up and/or drive up to the point adjacent to the detected lane entry point from step 840 (e.g., as described above with reference to FIGS. 2-4). In some examples, process 800 can cause the vehicle to quickly and/or aggressively accelerate if the vehicle passing aggression level is set to high (e.g., as described above with reference to FIGS. 1, 3, and 5). In some examples, process 800 can cause the vehicle to slowly accelerate if the vehicle passing aggression level is set to low or moderate (e.g., as described above with reference to FIGS. 1, 3, and 5). In some examples, process 800 can transition to step 830 and abort the automated pass operation if a lane entry point is not detected after a threshold time (e.g., 10 seconds, 30 seconds, or 1 minute).

At step 860, process 800 can determine whether the detected lane entry point from step 840 has closed (e.g., if the detected lane entry point from step 840 narrowed or closed so as to make it unsafe for the vehicle to merge into the driving lane at that entry point) (e.g., as described above with reference to FIG. 4). In accordance with a determination that the detected lane entry point from step 840 has not closed, process 800 transitions to step 870. In accordance with a determination that the detected lane entry point from step 840 has closed, process 800 returns to step 820.

At step 870, process 800 can cause the vehicle to return to the driving lane at the lane entry point detected at step 840 (e.g., merge back into the driving lane). In some examples, process 800 can cause the vehicle to quickly and/or aggressively merge back into the driving lane if the vehicle passing aggression level is set to high (e.g., as described above with reference to FIGS. 1, 3, and 5). In some examples, process 800 can cause the vehicle to slowly and/or cautiously merge back into the driving lane if the vehicle passing aggression level is set to low or moderate (e.g., as described above with reference to FIGS. 1, 3, and 5).

FIG. 9 illustrates an exemplary process 900 for automatically detecting and allowing other vehicles to pass to avoid a collision according to examples of the disclosure.

At step 910, process 900 can monitor the adjacent passing lane by processing data from one or more of the vehicle's sensors. In some examples, process 900 can monitor external information such as weather conditions (e.g., whether it is currently or was recently snowing or raining), map information, including information about the surface material of the road (e.g., pavement, dirt, asphalt, or gravel), and/or information from other vehicles, including information about their planned routes, at step 910. In some examples, this external information can be monitored through the vehicle's sensors or can be obtained from an external source (e.g., another vehicle and/or an internet source). In some examples, process 900 can monitor communications from other vehicles (e.g., as described above with reference to FIGS. 1, 4, and 6-7).

At step 920, process 900 can detect a passing vehicle (e.g., detect a vehicle driving along the same direction on the adjacent passing lane or detect a vehicle driving in the opposite direction in the same lane) through its one or more sensors. In some examples, process 900 can detect a passing vehicle through received wireless communications (e.g., as described above with reference to FIGS. 1, 4, and 6-7). In some examples, process 900 can cause the vehicle to send an acknowledgement (or any form of wireless communication) to the passing vehicle (e.g., as described above with reference to FIG. 6). In some examples, this acknowledgement can indicate whether the vehicle will allow the passing vehicle to merge into the driving lane in front of it (e.g., as described above with reference to FIG. 6). In some examples, process 900 can cause the vehicle to send raw data about the vehicle's surroundings (one or more characteristics about the road and/or one or more characteristics about other vehicles) from its one or more sensors. In some examples, process 900 can cause the vehicle to ignore and/or deny passing requests if the vehicle passing aggression level is set to high. In some examples, process 900 can cause the vehicle to speed up and close any gap between it and any vehicle in front of it (e.g., not allow the passing car to merge into the driving lane in front of the vehicle) if the vehicle passing aggression level is set to high. In some examples, process 900 can activate a visual and/or audio indicator (e.g., flash the headlights and/or honk the horn), cause the vehicle to slow down, and/or pull over to the shoulder to avoid a collision.

At step 930, process 900 can detect whether the passing vehicle is merging into the driving lane in front of the vehicle. In accordance with a determination the passing vehicle is merging into the driving lane in front of the vehicle, process 900 transitions to step 940. In accordance with a determination that the passing vehicle is not merging into the driving lane in front of the vehicle, process 900 returns to step 910.

At step 940, process 900 can cause the vehicle to allow the passing vehicle to merge into the driving lane in front of the vehicle (e.g., allow the passing vehicle to pass). In some examples, process 900 can cause the vehicle to slow down and/or create a lane entry point for the passing vehicle (e.g., as described above with reference to FIGS. 2-4 and 7-8). In some examples, process 900 can cause the vehicle to maintain a lane entry point for the passing vehicle (e.g., as described above with reference to FIGS. 2-4 and 7-8). In some examples, process 900 can cause the vehicle to only allow the passing vehicle to merge into the driving lane in front of the vehicle to avoid a collision if the vehicle passing aggression level is set to high. In some examples, process 900 can notify the passing vehicle whether it can pass the vehicle and/or send any information to the passing vehicle (e.g., as described above with reference to FIGS. 1, 4, 6, and 7).

Thus, the examples of the disclosure provide various ways to perform automated passing operations.

Therefore, according to the above, some examples of the disclosure are directed to a system comprising: one or more sensors; communication circuitry; one or more processors coupled to the one or more sensors and the communication circuitry; and a memory including instructions, which when executed by the one or more processors, cause the one or more processors to perform a method comprising: determining one or more characteristics about an area surrounding a vehicle via the one or more sensors, wherein: the one or more characteristics about the area surrounding the vehicle comprise one or more of: one or more characteristics about a road on which the vehicle is traveling; and one or more characteristics about one or more other vehicles on the road; determining that the one or more vehicle passing criteria are satisfied; determining whether passing is allowed on the road at a current location of the vehicle; and in response to determining whether passing is allowed: in accordance with a determination that passing is allowed, performing an automated pass operation to pass the one or more other vehicles; in accordance with a determination that passing is not allowed, forgoing performing the automated pass operation to pass the one or more other vehicles. Additionally or alternatively to one or more of the examples disclosed above, in some examples, the method further comprises: determining that the one or more vehicle passing criteria are not satisfied; and in response to determining that the one or more vehicle passing criteria are not satisfied, forgoing performing the automated pass operation to pass the one or more other vehicles. Additionally or alternatively to one or more of the examples disclosed above, in some examples, the one or more vehicle passing criteria are satisfied when the speed of the one or more other vehicles is below the speed limit of the road. Additionally or alternatively to one or more of the examples disclosed above, in some examples, the one or more vehicle passing criteria are not satisfied when the speed of the one or more other vehicles is at or above the speed limit of the road. Additionally or alternatively to one or more of the examples disclosed above, in some examples, performing the automated pass operation comprises: broadcasting a passing request to the one or more other vehicles via the communication circuitry; determining whether an acknowledgement is received; and in response to determining whether the acknowledgement is received: in accordance with a determination that the acknowledgement is received, performing a coordinated pass operation; in accordance with a determination that the acknowledgement is not received, performing a safe pass operation, different from the coordinated pass operation. Additionally or alternatively to one or more of the examples disclosed above, in some examples, determining that the one or more vehicle passing criteria are satisfied comprises determining a current vehicle passing aggression level from vehicle aggression levels, wherein the vehicle passing aggression levels comprise at least one of: a high vehicle passing aggression level; a moderate vehicle passing aggression level; and a low vehicle passing aggression level. Additionally or alternatively to one or more of the examples disclosed above, in some examples, in accordance with a determination that the current vehicle passing aggression level is the low vehicle passing aggression level, the one or more vehicle passing criteria are satisfied when the one or more other vehicles are not moving. Additionally or alternatively to one or more of the examples disclosed above, in some examples, in accordance with a determination that the current vehicle passing aggression level is the moderate vehicle passing aggression level, the one or more vehicle passing criteria are satisfied when the speed of the one or more other vehicles is below a threshold speed. Additionally or alternatively to one or more of the examples disclosed above, in some examples, in accordance with a determination that the current vehicle passing aggression level is the moderate vehicle passing aggression level, the one or more vehicle passing criteria are not satisfied when the speed of the one or more other vehicles is equal to or above the threshold speed. Additionally or alternatively to one or more of the examples disclosed above, in some examples, in accordance with a determination that the current vehicle passing aggression level is the high vehicle passing aggression level, the one or more vehicle passing criteria are satisfied when the speed of the one or more other vehicles is below a speed limit of the road. Additionally or alternatively to one or more of the examples disclosed above, in some examples, in accordance with a determination that the current vehicle passing aggression level is the high vehicle passing aggression level, the one or more vehicle passing criteria are not satisfied when the speed of the one or more other vehicles is equal to or above the speed limit of the road. Additionally or alternatively to one or more of the examples disclosed above, in some examples, in accordance with a determination that the current vehicle passing aggression level is the high vehicle passing aggression level, and the one or more other vehicles are not autonomous vehicles, the one or more vehicle passing criteria are satisfied when the speed of the one or more other vehicles is below a speed limit of the road, and in accordance with the determination that the current vehicle passing aggression level is the high vehicle passing aggression level, and the one or more other vehicles are not autonomous vehicles, the one or more vehicle passing criteria are not satisfied when the speed of the one or more other vehicles is equal to or above the speed limit of the road. Additionally or alternatively to one or more of the examples disclosed above, in some examples, in accordance with a determination that the current vehicle passing aggression level is the high vehicle passing aggression level, the one or more vehicle passing criteria are satisfied when the speed of the one or more other vehicles is below a threshold speed. Additionally or alternatively to one or more of the examples disclosed above, in some examples, in accordance with a determination that the current vehicle passing aggression level is the high vehicle passing aggression level, the one or more vehicle passing criteria are not satisfied when the speed of the one or more other vehicles is equal to or above the threshold speed. Additionally or alternatively to one or more of the examples disclosed above, in some examples, performing the coordinated pass operation comprises: establishing communication with the one or more other vehicles via the communication circuitry; monitoring information from the one or more other vehicles; determining whether it is safe to pass the one or more other vehicles; and in response to determining whether it is safe to pass the one or more other vehicles: in accordance with a determination that it is safe to pass the one or more other vehicles: causing the vehicle to move out of a driving lane to an adjacent lane; causing the vehicle to drive past the one or more other vehicles; and causing the vehicle to return to the driving lane; in accordance with a determination that it is not safe to pass the one or more other vehicles, aborting the coordinated pass operation. Additionally or alternatively to one or more of the examples disclosed above, in some examples, in accordance with a determination that the current vehicle passing aggression level is the high vehicle passing aggression level, causing the vehicle to move out of the driving lane to the adjacent lane comprises causing the vehicle to aggressively move out of the driving lane to the adjacent lane. Additionally or alternatively to one or more of the examples disclosed above, in some examples, in accordance with a determination that the current vehicle passing aggression level is the high vehicle passing aggression level, causing the vehicle to drive past the one or more other vehicles comprises causing the vehicle to aggressively drive past the one or more other vehicles. Additionally or alternatively to one or more of the examples disclosed above, in some examples, in accordance with a determination that the current vehicle passing aggression level is the high vehicle passing aggression level, causing the vehicle to return to the driving lane comprises causing the vehicle to aggressively return to the driving lane. Additionally or alternatively to one or more of the examples disclosed above, in some examples, performing the safe pass operation comprises: causing the vehicle to move out of a driving lane to an adjacent lane; determining whether it is safe to pass the one or more other vehicles; and in response to determining whether it is safe to pass the one or more other vehicles: in accordance with a determination that it is safe to pass the one or more other vehicles: detecting a lane entry point; causing the vehicle to drive to a point adjacent to the lane entry point; determining that the lane entry point has not closed; and causing the vehicle to return to the driving lane at the lane entry point; in accordance with a determination that it is not safe to pass the one or more other vehicles, aborting the safe pass operation. Additionally or alternatively to one or more of the examples disclosed above, in some examples, in accordance with a determination that the current vehicle passing aggression level is the high vehicle passing aggression level, causing the vehicle to move out of the driving lane to the adjacent lane comprises causing the vehicle to aggressively move out of the driving lane to the adjacent lane. Additionally or alternatively to one or more of the examples disclosed above, in some examples, in accordance with a determination that the current vehicle passing aggression level is the high vehicle passing aggression level, causing the vehicle to drive to the point adjacent to the lane entry point comprises causing the vehicle to aggressively drive to the point adjacent to the lane entry point. Additionally or alternatively to one or more of the examples disclosed above, in some examples, in accordance with a determination that the current vehicle passing aggression level is the high vehicle passing aggression level, causing the vehicle to return to the driving lane at the lane entry point and comprises causing the vehicle to aggressively return to the driving lane at the lane entry point.

Some examples of the disclosure are directed to a non-transitory computer-readable medium including instructions, which when executed by one or more processors, cause the one or more processors to perform a method comprising: determining one or more characteristics about an area surrounding a vehicle via one or more sensors, wherein: the one or more characteristics about the area surrounding the vehicle comprise one or more of: one or more characteristics about a road on which the vehicle is traveling; and one or more characteristics about one or more other vehicles on the road; determining that one or more vehicle passing criteria are satisfied; determining whether passing is allowed on the road at a current location of the vehicle; and in response to determining whether passing is allowed: in accordance with a determination that passing is allowed, performing an automated pass operation to pass the one or more other vehicles; in accordance with a determination that passing is not allowed, forgoing performing the automated pass operation to pass the one or more other vehicles.

Some examples of the disclosure are directed to a vehicle comprising: one or more sensors; communication circuitry; one or more processors; and a memory including instructions, which when executed by the one or more processors, cause the one or more processors to perform a method comprising: determining one or more characteristics about an area surrounding the vehicle via the one or more sensors, wherein: the one or more characteristics about the area surrounding the vehicle comprise one or more of: one or more characteristics about a road on which the vehicle is traveling; and one or more characteristics about one or more other vehicles on the road; determining that one or more vehicle passing criteria are satisfied; determining whether passing is allowed on the road at a current location of the vehicle; and in response to determining whether passing is allowed: in accordance with a determination that passing is allowed, performing an automated pass operation to pass the one or more other vehicles; in accordance with a determination that passing is not allowed, forgoing performing the automated pass operation to pass the one or more other vehicles.

Some examples of the disclosure are directed to a method comprising: determining one or more characteristics about an area surrounding a vehicle via the one or more sensors, wherein: the one or more characteristics about the area surrounding the vehicle comprise one or more of: one or more characteristics about a road on which the vehicle is traveling; and one or more characteristics about one or more other vehicles on the road; determining that one or more vehicle passing criteria are satisfied; determining whether passing is allowed on the road at a current location of the vehicle; and in response to determining whether passing is allowed: in accordance with a determination that passing is allowed, performing an automated pass operation to pass the one or more other vehicles; in accordance with a determination that passing is not allowed, forgoing performing the automated pass operation to pass the one or more other vehicles.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
one or more sensors;
communication circuitry;
one or more processors coupled to the one or more sensors and the communication circuitry; and
a memory including instructions, which when executed by the one or more processors, cause the one or more processors to perform a method comprising:
determining one or more characteristics about an area surrounding a vehicle via the one or more sensors, wherein:
the one or more characteristics about the area surrounding the vehicle comprise one or more of:
one or more characteristics about a road on which the vehicle is traveling; and
one or more characteristics about one or more other vehicles on the road;
determining that the one or more vehicle passing criteria are satisfied;
determining whether passing is allowed on the road at a current location of the vehicle; and
in response to determining whether passing is allowed:
in accordance with a determination that passing is allowed, performing an automated pass operation to pass the one or more other vehicles;
in accordance with a determination that passing is not allowed, forgoing performing the automated pass operation to pass the one or more other vehicles.

2. The system of claim 1, wherein the method further comprises:
determining that the one or more vehicle passing criteria are not satisfied; and
in response to determining that the one or more vehicle passing criteria are not satisfied, forgoing performing the automated pass operation to pass the one or more other vehicles.

3. The system of claim 1, wherein:
the one or more vehicle passing criteria are satisfied when the speed of the one or more other vehicles is below the speed limit of the road.

4. The system of claim 3, wherein:
the one or more vehicle passing criteria are not satisfied when the speed of the one or more other vehicles is at or above the speed limit of the road.

5. The system of claim 1, wherein:
performing the automated pass operation comprises:
broadcasting a passing request to the one or more other vehicles via the communication circuitry;
determining whether an acknowledgement is received; and
in response to determining whether the acknowledgement is received:
in accordance with a determination that the acknowledgement is received, performing a coordinated pass operation;
in accordance with a determination that the acknowledgement is not received, performing a safe pass operation, different from the coordinated pass operation.

6. The system of claim 5, wherein:
determining that the one or more vehicle passing criteria are satisfied comprises determining a current vehicle passing aggression level from vehicle aggression levels, wherein the vehicle passing aggression levels comprise at least one of:
a high vehicle passing aggression level;
a moderate vehicle passing aggression level; and
a low vehicle passing aggression level.

7. The system of claim 6, wherein:
in accordance with a determination that the current vehicle passing aggression level is the low vehicle passing aggression level, the one or more vehicle passing criteria are satisfied when the one or more other vehicles are not moving.

8. The system of claim 6, wherein:
in accordance with a determination that the current vehicle passing aggression level is the moderate vehicle passing aggression level, the one or more vehicle passing criteria are satisfied when the speed of the one or more other vehicles is below a threshold speed.

9. The system of claim 8, wherein:
in accordance with a determination that the current vehicle passing aggression level is the moderate vehicle passing aggression level, the one or more vehicle passing criteria are not satisfied when the speed of the one or more other vehicles is equal to or above the threshold speed.

10. The system of claim 6, wherein:
in accordance with a determination that the current vehicle passing aggression level is the high vehicle passing aggression level, the one or more vehicle passing criteria are satisfied when the speed of the one or more other vehicles is below a speed limit of the road.

11. The system of claim 10, wherein:
in accordance with a determination that the current vehicle passing aggression level is the high vehicle passing aggression level, the one or more vehicle passing criteria are not satisfied when the speed of the one or more other vehicles is equal to or above the speed limit of the road.

12. The system of claim 6, wherein:
in accordance with a determination that the current vehicle passing aggression level is the high vehicle passing aggression level, and the one or more other vehicles are not autonomous vehicles, the one or more vehicle passing criteria are satisfied when the speed of the one or more other vehicles is below a speed limit of the road, and
in accordance with the determination that the current vehicle passing aggression level is the high vehicle passing aggression level, and the one or more other vehicles are not autonomous vehicles, the one or more vehicle passing criteria are not satisfied when the speed of the one or more other vehicles is equal to or above the speed limit of the road.

13. The system of claim 6, wherein:
in accordance with a determination that the current vehicle passing aggression level is the high vehicle passing aggression level, the one or more vehicle passing criteria are satisfied when the speed of the one or more other vehicles is below a threshold speed.

14. The system of claim 13, wherein:
in accordance with a determination that the current vehicle passing aggression level is the high vehicle passing aggression level, the one or more vehicle passing criteria are not satisfied when the speed of the one or more other vehicles is equal to or above the threshold speed.

15. The system of claim 6, wherein:
performing the coordinated pass operation comprises:
establishing communication with the one or more other vehicles via the communication circuitry;
monitoring information from the one or more other vehicles;
determining whether it is safe to pass the one or more other vehicles; and
in response to determining whether it is safe to pass the one or more other vehicles:
in accordance with a determination that it is safe to pass the one or more other vehicles:
causing the vehicle to move out of a driving lane to an adjacent lane;
causing the vehicle to drive past the one or more other vehicles; and
causing the vehicle to return to the driving lane;
in accordance with a determination that it is not safe to pass the one or more other vehicles, aborting the coordinated pass operation.

16. The system of claim 15, wherein:
in accordance with a determination that the current vehicle passing aggression level is the high vehicle passing aggression level, causing the vehicle to move out of the driving lane to the adjacent lane comprises causing the vehicle to aggressively move out of the driving lane to the adjacent lane.

17. The system of claim 15, wherein:
in accordance with a determination that the current vehicle passing aggression level is the high vehicle passing aggression level, causing the vehicle to drive past the one or more other vehicles comprises causing the vehicle to aggressively drive past the one or more other vehicles.

18. The system of claim 15, wherein:
in accordance with a determination that the current vehicle passing aggression level is the high vehicle passing aggression level, causing the vehicle to return to the driving lane comprises causing the vehicle to aggressively return to the driving lane.

19. The system of claim 6, wherein:
performing the safe pass operation comprises:
causing the vehicle to move out of a driving lane to an adjacent lane;
determining whether it is safe to pass the one or more other vehicles; and
in response to determining whether it is safe to pass the one or more other vehicles:
in accordance with a determination that it is safe to pass the one or more other vehicles:
detecting a lane entry point;
causing the vehicle to drive to a point adjacent to the lane entry point;
determining that the lane entry point has not closed; and
causing the vehicle to return to the driving lane at the lane entry point;
in accordance with a determination that it is not safe to pass the one or more other vehicles, aborting the safe pass operation.

20. A vehicle comprising:
one or more sensors;
communication circuitry;
one or more processors; and
a memory including instructions, which when executed by the one or more processors, cause the one or more processors to perform a method comprising:
determining one or more characteristics about an area surrounding the vehicle via the one or more sensors, wherein:
the one or more characteristics about the area surrounding the vehicle comprise one or more of:
one or more characteristics about a road on which the vehicle is traveling; and
one or more characteristics about one or more other vehicles on the road;
determining that one or more vehicle passing criteria are satisfied;
determining whether passing is allowed on the road at a current location of the vehicle; and
in response to determining whether passing is allowed:
in accordance with a determination that passing is allowed, performing an automated pass operation to pass the one or more other vehicles;
in accordance with a determination that passing is not allowed, forgoing performing the automated pass operation to pass the one or more other vehicles.
